(19) United States
(12) Patent Application Publication
(10) Pub. No.: US 2024/0273442 A1
(43) Pub. Date: Aug. 15, 2024

(54) Machine Learning Based Sales Order Fulfilment Prediction

(71) Applicant: Oracle International Corporation, Redwood Shores, CA (US)

(72) Inventors: Akash BAVISKAR, Dist Jalgaon (IN); Krishnan RAMANATHAN, Kadubeesanahalli (IN); Kausik MISRA, Fremont, CA (US); Ramamurthy SHANKARACHETTY, Bangalore (IN)

(21) Appl. No.: 18/199,645

(22) Filed: May 19, 2023

(30) Foreign Application Priority Data
Feb. 15, 2023 (IN) 202341010151

(51) Int. Cl. G06Q 10/0637

(52) U.S. Cl. CPC G06Q 10/06375

(57) ABSTRACT

Embodiments predict a sales order fulfillment of an item. Embodiments receive historical data including past sales orders, and extracts a plurality of machine learning (“ML”) features from the historical data. Embodiments use a portion of the plurality of ML features to train one or more classifiers and generate labeled ML features from the trained classifiers. Embodiments train a ML regression model with the extracted ML features and the labeled ML features. Embodiments then receive a new sales order and generate a prediction on a delivery date for the new sales order using the trained ML regression model.

### FIELD

One embodiment is directed generally to a computer system, and in particular to predicting sales order fulfillment using a computer system.

### BACKGROUND INFORMATION

Sales or purchase orders received by an enterprise seller generally result in the enterprise providing an estimated sales delivery data. Providing an accurate sales delivery date for a purchase order is important for several reasons. Customers rely on the delivery date promised by the seller to plan and schedule their own activities. Providing an accurate delivery date helps manage customer expectations and ensures that they receive the product in time. Further, accurately delivering products on time builds trust and confidence in the seller. If the seller provides an inaccurate delivery date, customers may lose trust in the seller and look for alternative suppliers.

Further, providing an accurate delivery date helps the seller manage their inventory effectively. If the seller promises a delivery date that they cannot fulfill, they may run out of stock and lose future sales opportunities. Further, if the seller manufactures or sources the products, providing an accurate delivery date helps manage production schedules and ensures that they have enough time to fulfill the order.

In contrast, providing an inaccurate delivery date can result in unnecessary costs for both the seller and the customer. For example, if the seller promises a delivery date that they cannot fulfill, they may need to expedite shipping or incur additional expenses to meet the promised date.

### SUMMARY

Embodiments predict a sales order fulfillment of an item. Embodiments receive historical data including past sales orders, and extracts a plurality of machine learning (“ML”) features from the historical data. Embodiments use a portion of the plurality of ML features to train one or more classifiers and generate labeled ML features from the trained classifiers. Embodiments train a ML regression model with the extracted ML features and the labeled ML features. Embodiments then receive a new sales order and generate a prediction on a delivery date for the new sales order using the trained ML regression model.

### BRIEF DESCRIPTION OF THE DRAWINGS

FIG. 1 is a screenshot of a rule design and run time of a sales order system that provides delivery dates in accordance to embodiments.

FIG. 2 is a block diagram of a computer server/system in accordance with an embodiment of the present invention.

FIG. 3 is a block/flow diagram of a sales order fulfillment prediction system in accordance to embodiments.

FIG. 4 is a flow diagram of the functionality of sales order fulfillment predictor module of FIG. 2 for sales order fulfillment in accordance with one embodiment.

FIG. 5 is an overview diagram of elements of an inventory and transportation monitoring network/system that can implement embodiments of the invention and is included in the functionality of system of FIG. 2 and/or the system of FIG. 3.

FIG. 6 illustrates the entities/sub-entities that may form a planned trip in accordance to embodiments.

FIG. 7 is a block diagram of a gateway architecture in accordance to embodiments of the invention.

Further embodiments, details, advantages, and modifications will become apparent from the following detailed description of the embodiments, which is to be taken in conjunction with the accompanying drawings.

### DETAILED DESCRIPTION

One embodiment is a machine learning system that implements multiple classifiers to generate labeled features in order to train a machine learning system that predicts sales order fulfillment. The trained machine learning system predicts a delay in the delivery of a sales order relative to a promised/estimated delivery date.

As disclosed, when a customer places a purchase order to an enterprise, an internal team at the enterprise generally provides a promised or estimated delivery date to the customer manually or automatically based on internal parameters. Embodiments therefore predict the delay in delivery with respect to the promised delivery date (i.e. a prediction if the sales order can be delivered by the enterprise on time or not). If the predicted delay is positive, necessary steps can be taken well in advance and mitigation strategy can be implemented to reduce a negative business impact or the customer can be notified about the delay well in advance.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

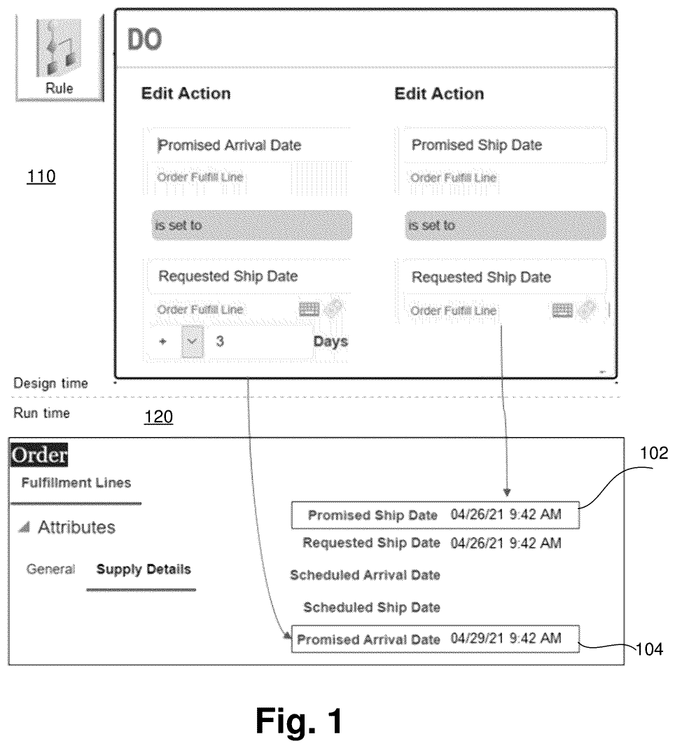

FIG. 1 is a screenshot of a rule design and run time of a sales order system that provides delivery dates in accordance to embodiments. Within the rule design 110, the promised arrival/delivery date in the example of FIG. 1 is set for 3 days later than the promised ship date. As a result, during run time at 120, the promised arrival date at 104 is automatically set for 3 days greater than the promised ship date at 102.

In general, the promised date of the sales order is the delivery date that the seller commits to is based on product availability, processing and handling time. The promised/estimated delivery date is the date when the customer can expect to receive an ordered product/item (e.g., promised arrival data 104). In a sales order system, in one embodiment, in order to set a promised delivery date, a sales team checks product specification, quantities and the desired delivery date. The product availability is checked based on inventory levels, production schedules and supplier lead time. If necessary, a supplier negotiation is carried out for raw material and components. Resource availability is verified for labor and equipment. Based on some or all of these factors, a promised arrival date is recorded in the system at 104. The customer is then typically regularly updated on order status and changes to the promised date.

However, delays in the promised arrival date can arise due to a myriad of reasons, including inadequate inventory, production issues, inadequate manpower to pick/pack/ship during peak times, poor coordination or payment issues. Further reasons may be beyond the enterprise's control, including shipping and logistics issues and incorrect information (e.g., bad addresses).

The amount of typical delay may depends on product/service and industry. For example, the typical delay in the retail industry is 24-48 hours, for ecommerce, a few days to a week. For manufacturing, the typical delay may be weeks to months. For healthcare, the typical delay can be weeks due to the need for specialized handling and transportation.

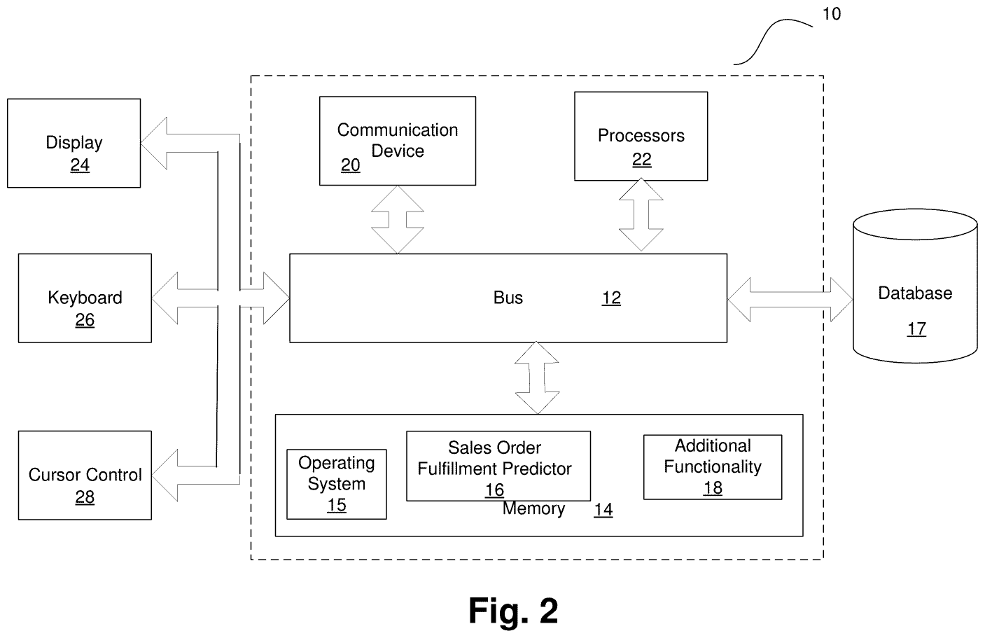

FIG. 2 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. System 10 can centrally provide the functionality for all or some of the components shown in the below figures.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an sales order fulfillment predictor module 16 that provides a prediction on whether a promised delivery date will be achieved, and all other functionality disclosed herein. System 10 can be part of a larger system. Therefore, system 10 can include one or more additional functional modules 18 to include the additional functionality, such as “Fusion Financials” from Oracle Corp., including “Oracle Fusion Analytic Warehouse” or an enterprise resource planning (“ERP”) system that includes a sales order fulfillment function. A database 17 is coupled to bus 12 to provide centralized storage for modules 16 and 18 and store customer data, product data, transactional data, etc. In one embodiment, database 17 is a relational database management system (“RDBMS”) that can use Structured Query Language (“SQL”) to manage the stored data.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), or software-as-a-service (“SAAS”) architecture.

As disclosed, predicting and giving an accurate promised/estimated delivery date to the customer when a customer places a purchase order to an enterprise is an important aspect of customer satisfaction. A delay in order delivery with respect to given promised delivery date can cause bad customer experiences. In addition, using an unnecessary high buffer for possible delays while promising the delivery date can again impact customer experience in a negative way.

Embodiments address the problem of predicting a delay in delivery with respect to promised delivery date by modelling the problem as a regression task where the target variable is the number of days between the actual delivery date and the purchase order submission date. In general, embodiments predict the number of days needed after the purchase order submission date to actually deliver the item to the customer's address. Using this prediction, embodiments automatically generate a predicted delivery date. The predicted delivery date may be in the form of the original promised delivery date provided to the customer (e.g., date 104 of FIG. 1) or a prediction on the number of days between the predicted delivery date and the promised delivery date.

At the time of making predictions in response to “live” data, the total number of days between the promised delivery date and the predicted delivery date is the delay in delivery. A positive value of delay means the order will be delivered after the promised delivery date and a negative value of delay means the order will be delivered before the promised delivery date.

As an example, consider a customer submitted a purchase order on Jan. 31, 2023 and the enterprise provided a promised delivery date to be Feb. 15, 2023 manually based on some internal evaluation. In contrast, embodiments, using a trained machine learning (“ML”) model, will predict the number of days required to deliver the order to the customer. For example, embodiments may predict that the order will be delivered in 20 days after the purchase order was placed, making the predicted delivery date Feb. 20, 2023, meaning the order will be predicted to be delayed by 5 days with respect to the promised delivery date.

After the purchase order is placed, embodiments can make predictions daily or in an interval of a few days as the order progresses, based on a configurable parameter. Based on the predicted number of days required to deliver the order to the customer, if embodiments are predicting that there will be a delay of “x” number of days, then necessary steps can be taken well in advance and a mitigation strategy can be implemented or at a minimum the customer can be informed about the potential delay in delivery date.

In embodiments, the following are considered the key steps involved in the process of sales order fulfilment from purchase order submission stage to the final customer delivery stage:
1. Customer places purchase order at the enterprise.
2. Sales order draft gets created at the enterprise.
3. Validation of order data attributes such as quantity, delivery address, etc. is performed.
4. Credit checks are done for the customer to verify no existing payment defaults are present.
5. Sales Order gets submitted for actual processing at warehouses.
6. Assigning order mechanism (Drop shipping/Back To Back/Normal Order): Each of these order mechanisms can take different time for order processing:
   a. Drop Shipping: In this case, a purchase order is placed to procurement and then procurement places a purchase order with supplier, then supplier directly ships the item to customer.
   b. Back To Back: In this case, supply is only created when needed, on demand, in direct reply to a purchase request.
   c. Normal Order: In this case, the supply already exists, so the flow reserves enough supply to meet demand from the sales order.
7. Shipping the order at assigned warehouse based on the quantity and size of items in the order, number of existing orders in the pipeline, workload at warehouses, Inventory availability, speed of workers and availability of workforce at warehouses.
8. Once the order is shipped, finally order is picked up by courier partner and final delivery is initiated.

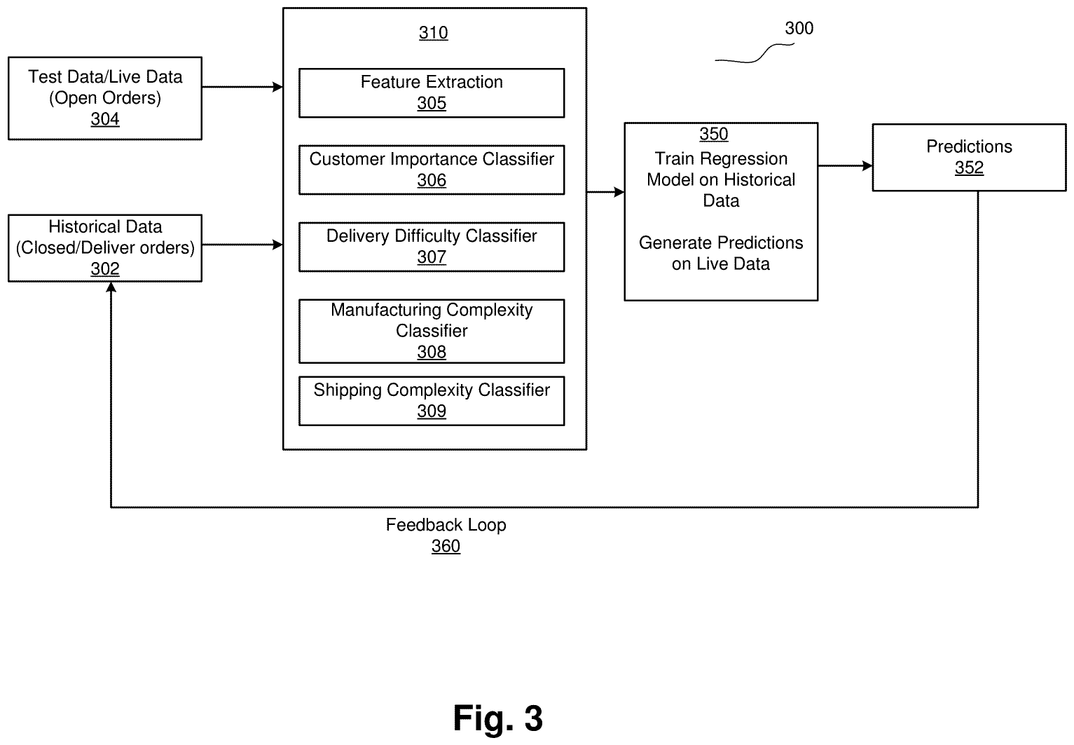

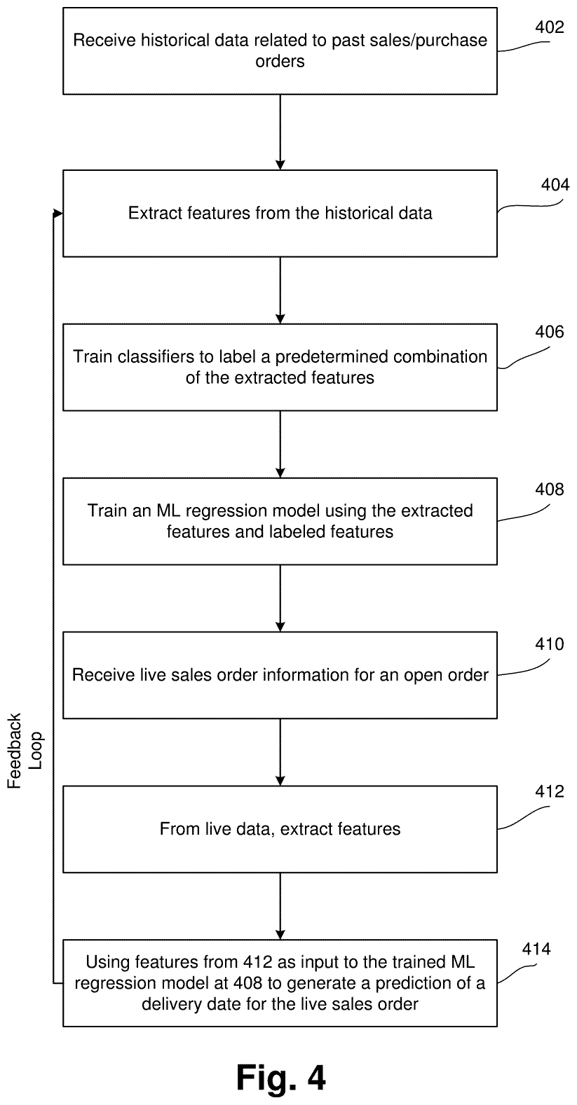

FIG. 3 is a block/flow diagram of a sales order fulfillment prediction system 300 in accordance to embodiments. In one embodiment, the functionality of the flow diagram of FIG. 3 (and FIG. 4 below) is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

In general, the functionality of FIG. 3 is training a ML regression model (e.g., Decision Tree Regressor, Random Forest Regressor, Gradient Boosting Regressor, Neural Network Regressor, etc.) for predicting the time required for delivering the sales order to the customer address.

At 302, historical data is received for training the ML model. The historical data is generated from closed sales orders.

At 304, live data (i.e., open sales orders) is received for which the predictions will apply after the ML model is trained.

At 310, ML model features are extracted 305 and/or generated using classifiers 306-309 from the historical data 302 and the live data 304. In embodiments, the features 310 are based on factors affecting the time required for sales order delivery. The following is the list of factors, from which categorical and numeric features will be extracted, for training ML model 350 (or using live data to generate a prediction), where the target variable is the number of days between actual delivery date and purchase order submission date:
1. Time required for validation of data attributes and creating order draft.
2. Time required for credit checks of the customer.
3. Type of order mechanism (Drop shipping/Back To Back/Normal Order).
4. Quantity and sizes of items in the Sales Order.
5. Item Type in Sales Order (a broader category assigned to the item).
6. Order Amount.
7. Payment Type (Cash/Check/Card).
8. Prepaid/Post-paid Order.
9. Discount Information.
10. Is “Prime”/Special Customer?
11. Customer Importance (High/Medium/Low): method to infer customer importance is disclosed below using customer importance classifier 306.
12. Was Sales Order placed on hold?
13. Reason for Hold (if it was placed on hold).
14. Is hold active?
15. How much time was the order kept on hold till date?
16. Number of existing orders in the pipeline at assigned warehouse on the day when purchase order was placed.
17. Number of existing orders of same stock keeping unit (“SKU”) in the pipeline at assigned warehouse on the day when purchase order was placed.
18. Average number of orders getting shipped at assigned warehouse daily.
19. Average number of orders of same SKU in the pipeline getting shipped at assigned warehouse daily.
20. Item shipping complexity: method to infer shipping complexity is disclosed below using shipping complexity classifier 309.
21. Weather forecast information for near future.
22. Inventory availability for SKUs in the order.
23. Complexity of manufacturing the item: method to infer manufacturing complexity is disclosed below using manufacturing complexity classifier 308.
24. Distance between Source warehouse and customer destination
25. Mode of transportation (Air/Water/Road).
26. Are Source warehouse and customer destination within same country and same state?
27. Average time taken by courier service for Source warehouse and customer destination route.
28. Level of difficulty of delivery to the location (High/Medium/Low): method to infer delivery difficulty level is disclosed below using delivery difficulty classifier 307.
29. Worker's Strikes information for near future.
30. Holidays in near future.
31. Seasonality (order submission Year/Month/Weekdays/Weekends, etc.).

ML model 350 is trained on the historical data, and generates predictions based on live data. Because ML model 350, in embodiments, is a regression problem, model 350 is evaluated based on metrics such as Root Mean Squared Error (“RMSE”) and Mean Absolute Error (“MAE”). Once the model 350 is trained, then predictions 352 are generated in response to receiving live data 304.

Specifically, after a purchase order is placed (i.e., live data received at 304), model 350 makes predictions daily or on an interval of every few days as the order progresses, which can be a configurable parameter. The predictions are made at multiple timestamps for each sales order. In connection with 310, the information needed to derive some of the features may not be available at every prediction timestamp. For example, for a purchase order submitted Jan. 31, 2023, and a prediction made on the next day on Feb. 1, 2023, the information on courier service may not be available at this particular timestamp. In that case, predictions can be made assuming the most frequent courier service on that particular route. Similarly appropriate assumptions can be made for other features in case information needed to derive that particular feature is not available at that particular timestamp.

System 300 further includes a feedback loop 360 that allows for existing open sales orders 304 to be added into training data 302 once that particular sales order gets closed. Therefore, ML model 350 can be continually retrained using updated training data.

In embodiments, a sales order system that implements prediction system 300 uses database tables for both the input data and the output data. An example input database table includes all the information required for calculating the ML model features disclosed above. An example output database table is as follows:

Output Table

| COLUMN NAME | DESCRIPTION |
|---|---|
| SALES_ORDER_ID | Unique Id Of Sales Order |
| PREDICTION_{—} | Timestamp when prediction |
| RUN_TIMESTAMP | was made by model |
| PROMISED_{—} | Initial promised delivery date |
| DELIVERY_DATE | provided by enterprise |
| PREDICTED_{—} | Predicted delay by ML model with respect |
| DELAY_IN_DAYS | PROMISED_DELIVERY_DATE |
| PREDICTED_{—} | Predicted delivery date with respect to |
| DELIVERY_DATE | PREDICTED_DELAY_IN_DAYS |
| DELAY_FACTORS | Reasons for delay in delivery |
| | or early delivery |

As shown in FIG. 3, in embodiments, some of the features generated/extracted to train model 350 are generated by classifiers 306-309. Each classifier labels the data as High/Medium/Low so it can be used as labeled categorical features in regression model 350 for sales order fulfilment prediction. Each classifier 306-309 is separately trained for deriving each of the corresponding features. Each of the classifiers will have 3 categories (High/Medium/Low) and will have 4 distinct training datasets.

In general, both features 305, which are extracted from closed sales orders, and are therefore generally labeled, and labeled features generated by classifiers 306-309, are used to train the regression model 350. For making predictions on open sales orders, features 305 are extracted and also features 306-309 are generated using the respective classifiers.

Embodiments create a human labelled or synthetic training datasets to train these classifiers. For each classifier 306-309, one embodiment creates human labelled training data using a manual effort as each un-labelled training sample will have to be labelled as High/Medium/Low. Other embodiments use a semi-supervised clustering method, such as k-means, to label the training data in a synthetic or semi-automatic way. Using the clustering method, embodiments divide the data into multiple clusters where each cluster contains similar samples. The number of clusters for k-means will be decided based on known methods, such as elbow curve or silhouette score. After creating the clusters, each cluster is analyzed and as each cluster will contain similar samples, a single label will be assigned (High/Medium/Low) to all samples belonging to the cluster. Therefore, embodiments get the labelled training data for each classifier 306-309.

The labeled training data (i.e., classifier model labeled data) is then used to train each separate classifier model 306-309. In embodiments, classifier models 306-309 are implemented by a supervised classifier model such as a decision tree. Once the classifier model is trained, it can be used to generate some of the input features for the regression model 350.

For classifier 306, which is trained to infer the importance of the customer, the training data includes historical information on customer behavior in the past. In embodiments, the following features will be extracted from the historical data for training customer importance classifier 306:
1. customer age with the enterprise;
2. frequency of placing order in days i.e. customer placing an order in x days;
3. number of orders placed by the customer so far;
4. sum of amount of orders placed so far;
5. average order value for this customer;
6. % of times payment made on time;
7. % of times payment made before due date;
8. % of times payment made after due date;
9. current outstanding amount for this customer;
10. number of defaulted payments;
11. defaulted amount till date.

For classifier 307, which is trained to infer difficulty of a location for delivering on-time from historical data, the training data includes information on all orders delivered to each location in the past. In embodiments, the following features will be extracted from the historical data for training delivery difficulty classifier 307:
1. does this location has limited delivery hours?
2. % of times orders delivered on time at this location (with regard to (“wrt”) all orders coming from any source location);
3. % of times orders delivered after due date at this location (wrt all orders coming from any source location);
4. % of times orders delivered before due date at this location (wrt all orders coming from any source location);
5. Average days required to deliver orders at this customer location (wrt all orders coming from any source location);
6. % of times orders delivered on time at this location (wrt specific orders on current source-destination route);
7. % of times orders delivered after due date at this location (wrt specific orders on current source-destination route);
8. % of times orders delivered before due date at this location (wrt specific orders on current source-destination route);
9. Average days required to deliver orders at this customer location (wrt specific orders on current source-destination route).

For classifier 308, which is trained to infer the complexity of manufacturing the item, the training data includes information on the item manufacturing process in the past. In embodiments, the following features will be extracted from the historical data for training manufacturing complexity classifier 308:
1. Average number of days required to manufacture this item;
2. Is this high precision item or high degree of accuracy required in the production process?
3. Does this item has custom/complex design specifications?
4. Is this item made up of multiple components?
5. Goes through multiple stage of production?
6. Needs quality control inspection?
7. Item with special material?

For classifier 309, which is trained to infer item shipping complexity, the training data includes information on the item shipping process in the past. In embodiments, the following features will be extracted from the historical data for training shipping complexity classifier 309:
1. volume of the item (length, width, height);
2. weight of the item;
3. is the item fragile?
4. is special packaging and handling required for this item?
5. is special storage (temperature requirements) required for this item?
6. is this a high demand item?
7. is there an inventory shortage currently for this item?
8. Average time required to ship this item.

FIG. 4 is a flow diagram of the functionality of sales order fulfillment predictor module 16 of FIG. 2 for sales order fulfillment in accordance with one embodiment.

At 402, historical data related to past sales/purchase orders is received.

At 404, features are extracted from the historical data.

At 406, using extracted features, classifiers are trained in order to label a predetermined combination of the extracted features. In embodiments, the classifiers include customer importance classifier 306, delivery difficulty classifier 307, manufacturing complexity classifier 308 and shipping complexity classifier 309. Each of the classifiers labels the combination of features as High, Medium or Low.

At 408, the extracted features and labeled features from 404 and 406 are used to train an ML regression model.

At 410, “live” sales order information is received for an open order. The live sales order includes a promised arrival date provided to the customer, such as date 104 of FIG. 1

At 412, for the live data, features mentioned in 305 are extracted and features 306-309 are generated using respective trained classifiers.

At 414, the features from 412 are input to the trained ML regression model at 408 to generate a prediction of a difference in the delivery date for the live sales order with respect to the promised arrival date. If a difference is predicted, corrective actions can be made. When the live sales order has been closed, the information related to that closed order (i.e., the actual delivery date, the difference between the actual delivery data and predicted deliver date, etc.) is added to the historical data and used for retraining both the classifiers and the regression models.

In addition to generating a prediction at 414 made on each individual open sales order, embodiments provide a list of top factors which contributed or resulted in a given prediction. In instances where the model has predicted that a particular sales order will be delayed by some x number of days, embodiments can provide reasons for the delay. Further, in instances where the model has predicted that a particular sales order will be delivered earlier than promised delivery date by y number of days, embodiments can provide reasons for the early delivery. The reasons for each sales order can be different based on the order scenario. In general ML feature importance scores are used in embodiments for explaining the model prediction, but these feature importance scores are at model level and not at a sample level. In contrast, in actuality, each sales order can be different and reasons for delay or early delivery can be different. Embodiments use SHapley Additive explanations (“SHAP”) and Local interpretable model-agnostic explanations (“LIME”) algorithms for getting sample level feature importance which ultimately gives top factors contributing to the prediction made by the ML model at the sample level. For an enterprise, embodiments will aggregate these top factors from the final output table and the most frequent reasons causing delay can be highlighted, so that the enterprise can act upon and fix them.

### IoT and GPS Tracking

In embodiments, in order to generate some of the features, such as the feature of “Inventory availability for SKUs in the order”, as well as determining when the inventory was actually delivered to the customer, inventory items as well as transportation related items are tracked. One embodiment uses Global Positioning System (“GPS”) or Internet of Things (“IoT”) based sensors attached to the vehicle and/or inventory in order to generate tracking based features used in embodiments. One embodiment uses a system such as the “Fleet Monitoring Cloud Service” from Oracle Corp. for creating and monitoring trips (i.e., “fleet management”), including inventory both in transit and in warehouses and other location.

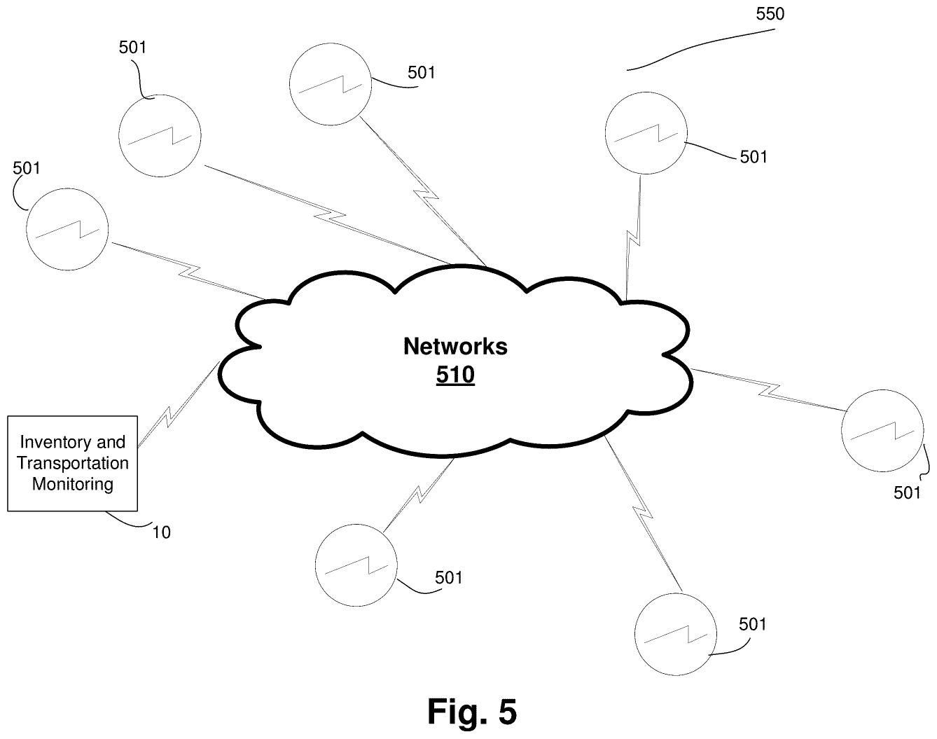

FIG. 5 is an overview diagram of elements of an inventory and transportation monitoring network/system 550 that can implement embodiments of the invention and is included in the functionality of system 10 of FIG. 2 and/or system 300 of FIG. 3. Network 550 includes multiple sensors 501 that form a sensor network 550 in combination with one or more networks 510. Each of sensors 501 can be considered an IoT device with the associated processing and communication capabilities. System 550 may include a relatively large number of sensors 501. For example, for a fleet of “trucks” that are being monitored, each portion of the truck may include a sensor (e.g., the actual truck body and the one or more trailers that are being pulled by the truck, and each inventory item that is loaded into each of the trailers).

An IoT device can be any device that has a sensor attached to it and can transmit data from one object to another or to people with the help of Internet. IoT devices include wireless sensors, software, actuators, and computer devices. They are attached to a particular object that operates through the Internet, enabling the transfer of data among objects or people automatically without human intervention. Each of sensors 501 can include a processor/controller, and a communication interface that uses protocols such as Modbus, Zigbee, or proprietary protocols, to connect to an Edge Gateway.

Network 550 may be used for a variety of purposes, such as, for example, in the transportation industry, where vehicle fleet management is aided by the continuous acquisition of data by sensors that are attached to vehicles. In this embodiment, sensor network 550 may acquire data that may be monitored and processed for such purposes as aiding vehicle maintenance, optimizing vehicle routes, promoting driver safety, etc. Each of sensors 501 communicate, wirelessly or wired, through one or more networks 510. Networks 510 include the Internet, but may also include private on-premise networks that ultimately interface with the Internet as well as any other type of network that allows sensors 501 to communicate.

An inventory and transportation monitoring server 10 is coupled to networks 510 to send and receive data from sensors 501. Inventory and transportation monitoring server 10, as part of system/server 10 of FIG. 2, provides transportation and inventory based features used to train ML model 350 and generate predictions.

Embodiments include functionality that is included in a fleet monitoring system that monitors entities including trips, shipments, vehicles, equipment in vehicles, ship-orders, ship-units or packages, ship-items, and the drivers assigned to a trip. The “trip” is a collection of goods that is being transported, has been, or needs to be transported from one geographic location to another. The trip also encompasses the route defined for the movement of the goods.

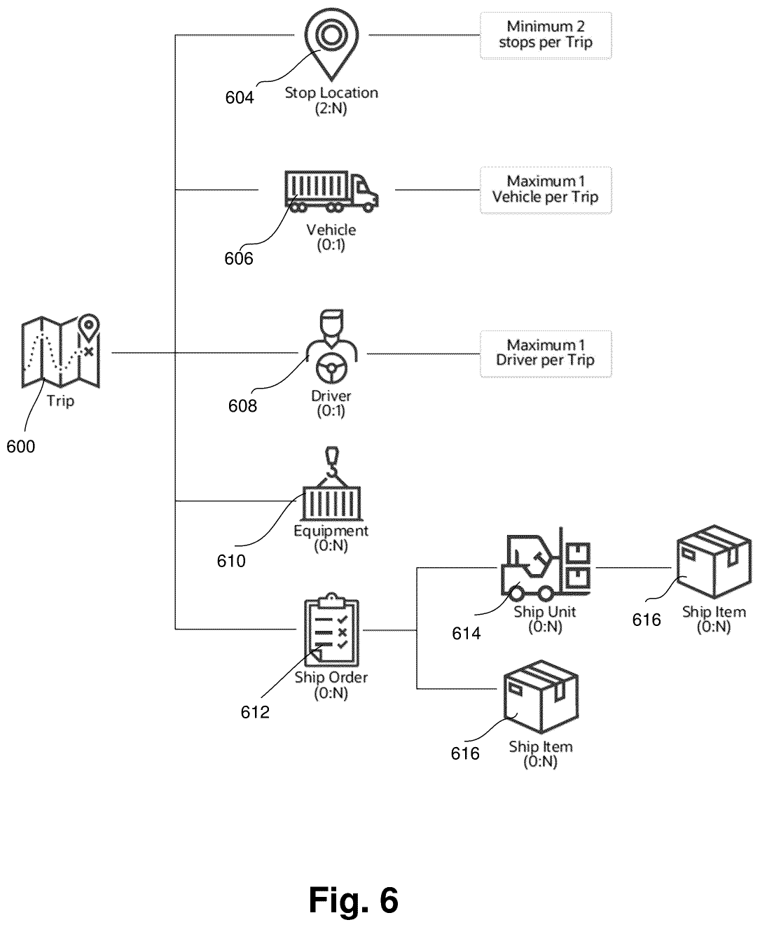

FIG. 6 illustrates the entities/sub-entities that may form a planned trip 600 in accordance to embodiments. In addition to the start location and the final destination location, not shown, sub-entities include stop locations 604, which are the intermediate stops between the source and destination. They are either delivery points or pick up points. Sub-entities further includes a vehicle 606, which is a conveyance such as a truck or a car for transporting inventory from a source location to a stop location.

Sub-entities further includes a driver 608, which is the driver assigned to the trip. Sub-entities further includes equipment 610, which represents any method of storage or transport used for the movement of goods in a trip from one location to another, such as, a trailer, container, flatbed, or a tank, and so on. It can have sensors/trackers attached for measuring attributes including GPS, temperature, humidity, shock, tilt, pressure, and so on.

Sub-entities further include ship-orders 612, which are part of the inventory metadata that contains order information required for transportation of goods from one location to another in a trip. Sub-entities further includes ship-units 614 that are a transportation handling unit that is used to facilitate ease of transportation in a trip. These can be wooden or metallic pallets, boxes, cartons, automotive racks, and so on. A ship-order can contain one or more ship-units. Sub-entities further include ship-items 616 that are an individual trackable inventory item or items that is being transported and monitored in a trip. It can belong to a ship-unit 614 or can be independent of ship-units 614.

Each of the items and sub-items shown in FIG. 6 can be tracked using a corresponding sensor 501 (e.g., an IoT sensor) that transmits the location of the item, and other information if needed, at predetermined time intervals, in the form of messages. The messages are received by inventory and transportation monitoring server 10.

### Sensor Gateway

In embodiments where there are a large number of IoT sensors 501, and/or some sensors are used for monitoring as disclosed above, while other sensors are used for other types of functionality, a gateway between the sensors and the cloud is implemented. Examples of other types of functionality for sensors 501 include measurement of temperature, humidity, CO2 levels, GPS, water level, water presence, electrical current/voltage, light, presence, etc. Small sensors or legacy devices can directly transmit their data to a nearby gateway instead of to the cloud, reducing their power consumption and increasing the sensors' battery life.

The gateway communicates with different types of sensors/devices using different protocols and then sends the data to a cloud service using a standard protocol. The gateway acts as a filter for the huge amount of data sent by the devices, processing the data and sending only relevant information to the cloud. Therefore, the processing and storage services is utilized optimally so that the need for processing and storage is reduced. Further, the response time for the sensors is considerably reduced. The nearby gateway receives the sensor data, processes it, and sends relevant commands back to the sensors. Further, gateways are highly secure and they also help secure the sensors and devices that are connected to them.

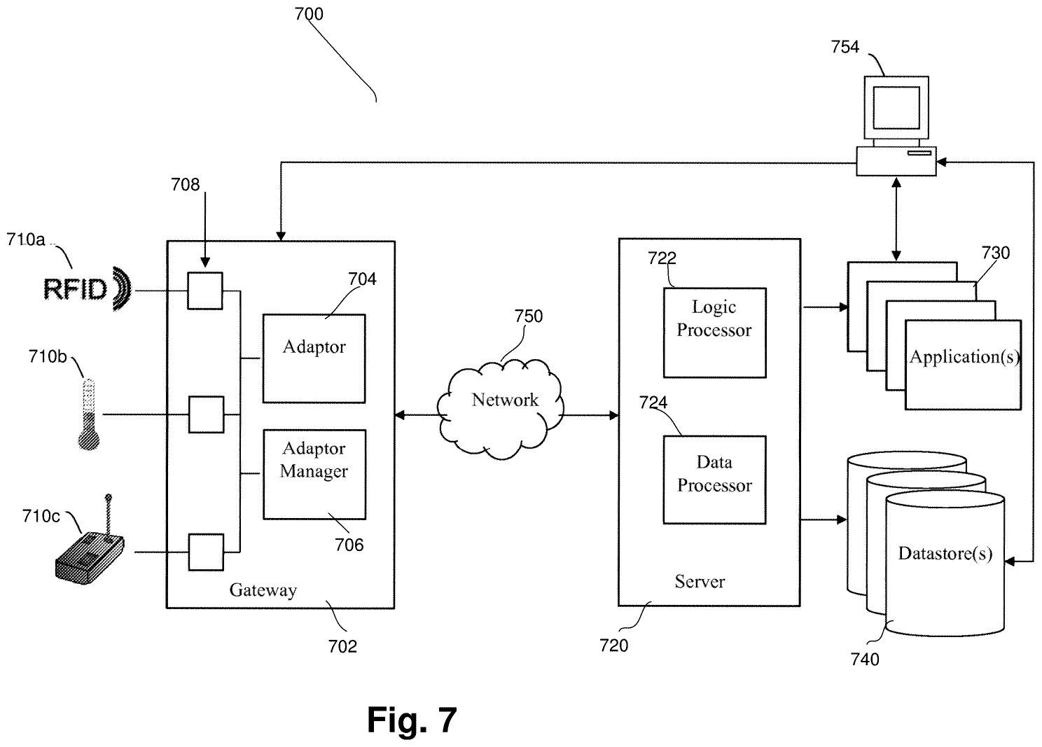

FIG. 7 is a block diagram of a gateway architecture 700 in accordance to embodiments of the invention. Architecture 700 permits effective integration between the systems in the operations technology portion and the systems in the information technology portion of the environment. Architecture 700 generally includes a gateway portion 702 having front-end data collection logic, and a server portion 720 to perform back-end processing of the collected data. To handle many different device/sensor types (including IoT sensors 501) and to provide the ability to handle high numbers of units being deployed in the field, embodiments provide a robust platform for handling issues such as: (a) sensor definition; (b) sensor management; (c) data capture; (d) data processing; (e) data transfer; (f) data storage; (g) analysis; and/or (h) visualizations. This architecture provides a framework for interfacing with any type of local device that may be deployed at a client site, and to allow data captured from those devices to be sent to a remote server, and to have the collected data be both locally and remotely programmatically processed. Gateway architecture 700, in general, can function as a sensor message receiving module that receives sensor messages.

Gateway 702 includes a sensor management module that handles the sensor code (e.g., that is implemented as custom code, such as Java code, specific to each sensor hardware). This module captures the sensor data in a generic way so that any type of data can be used. The gateway locally caches data so it can be pre-processed locally and no data is lost when there is no network connectivity. The data preprocessor performs actions such as data filtering using a set of rules. The system throttles the data so that data rates do not overwhelm the capabilities of the client gateway or the network. An internal data store may be included to store data in a platform-agnostic way. A data transfer module is employed to build the data for transmission. The system permits client gateways to talk to each other so as to establish a mesh network ensuring resiliency and connectedness.

In general, gateway 702 performs data acquisition and management of local devices 710a-c. The local devices 710a-c may include any type of equipment that can be suitably managed by architecture 700. For example, any number of sensors may be embedded within the local equipment at various sites. Examples of such sensors include RFID sensors at device 710a, temperature sensors at device 710b, and other types of smart devices, beacons, and/or machines at device 710c (including IoT sensors 501).

Local devices 710a-c can be configured to send data at regular intervals to gateway 702. Such data may include information to be captured from the local devices. For example, information that may be captured include operating conditions, metrics, pressure, vibration, temperature, and/or flow rate.

In additional to using sensor data for fleet management, as disclosed above, other examples of the uses for sensor data may include: (a) handling perishable goods, where the system continuously monitors the temperature, humidity and location of goods as they travel through the supply chain, where by monitoring these critical factors and taking quick action on alerts, one can significantly reduce the spoiled goods and as a result increase revenue; (b) managing heavy machinery, by tracking the locations of a company's equipment along with environment conditions and operating metrics of the equipment, thereby ensuring that the equipment is being operated properly, preventing machine failures, and ensuring that the equipment is being properly used to the organization's goods and services; and (c) providing product support, where products that are sold could communicate back to the maintenance organization with current status, diagnostic information, and available quantity of consumables, and where the provided information helps to deliver a better quality of service to customers by discovering potential failures before they impact the customer and also increase revenue through expanded service offerings and replenishment of consumables.

Gateway 702 includes an adaptor component 704 and an adaptor manager 706. Adaptor component 704 (also referred to herein as an “IoT adaptor”) manages the gateway's interaction with local devices 710a-c, and may include device-specific code components 708 to perform its processing with local devices 710a-c. Adapter manager 706 (also referred to herein as an “IoT adaptor manager”) is used to manage the operations, versioning, and/or provisioning of local devices 710a-c and adaptor component 704. In some embodiments, gateway 702 processes incoming data with local analytics (e.g., to analyze operating conditions and to identify fluctuations). To the extent necessary, alerts and data readings can be sent in real-time.

The data collected by gateway 702 are sent over a network 750 to server 720. Server 720 efficiently receives data from potentially a multitude of client gateways. The server module parses the data and caches it locally to expedite data capture. Pre-processing of the data may be performed for filtering, applying simple or complex script-based rules, etc. The data may be stored in an internal database. The persisted data can be forwarded to a corporate, generic table store. The server module may also take action based on the result of rules applied on the data, such as calling a web service, invoking further more complex rules, sending control data back to devices, etc. A generic table format can be used to store the sensor data within the enterprise application ecosystem. Keeping the relevant data within the ecosystem allows the use of standard tools in the enterprise application, such as reporting tools and form design tools. This means that users can use their pre-existing tools and systems to process the data from the operations technology (“OT”) side, which allows the user to use systems which they are well-versed in using to report on and add intelligence to the data that is captured. An open interface (e.g., a RESTful interface) enables the captured data to be enquired and allows the development of rich, responsive, up-to-date client interfaces.

At server 720, a logic processor 722 (also referred to herein as an “IoT logic processor”) and a data processor 724 (also referred to herein as an “IoT data processor”) are provided to implement analysis and alert processing. These components may include operations technology and industry-specific rules and scripts.

Server 720 may communicate with one or more applications 730. Such applications 730 may include, for example, functionality to implement inventory management, quality management, condition-based maintenance, and/or provide a visualization portal, as well as functionality of FIGS. 3-4 for sale order fulfillment predictions. Examples of these applications include, for example, Emergency Shutdown (“ESD”) systems, Supervisor Control and Data Acquisition (“SCADA”) systems, data analytics tools, BI (“business intelligence”) tools, customer relationship management (“CRM”) products, enterprise resource planning (“ERP”) products, enterprise marketing products, financials applications, and/or procurement applications. The application products are hosted on computing hardware operated by the cloud provider.

Server 720 may also manage the storage of the collected data into one or more datastores 740. Datastore 740 includes any combination of hardware and software that allows for ready access to the data that is located at a computer readable storage device. For example, datastore 740 could be implemented as computer memory operatively managed by an operating system. The data in datastore 740 could also be implemented as database objects and/or files in a file system.

One or more users may exist at one or more user stations 754 that interact with the architecture 700. User station 754 includes any type of computing station that may be used to operate or interface with architecture 700. Examples of such user stations include, for example, workstations, personal computers, mobile devices, or remote computing terminals. The user station comprises a display device, such as a display monitor, for displaying a user interface to users at the user station. The user station also comprises one or more input devices for the user to provide operational control over the activities of the architecture 700, such as a mouse or keyboard to manipulate a pointing object in a graphical user interface to generate user inputs.

Either server 720 or the user at user station 754 may provide control signals to gateway 702 to control the operation of the gateway 702 and/or the local devices 710a-c. The control signals may be used to control any operation necessary at the gateway and/or local device 710a-c, including for example, to update and provision control software on the gateway and/or to control operation of the local device.

In embodiments, the generated sensor messages are generated as a specialized data structure that includes attributes of sensors, vehicles, etc. In embodiments, the specialized data structure is in the form of an electronic document (e.g., an XML document) and is stored in database 17. A “data structure,” as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of predicting a sales order fulfillment of an item, the method comprising:
receiving historical data comprising past sales orders;
extracting a plurality of machine learning (ML) features from the historical data;
using a portion of the plurality of ML features to train one or more classifiers;
generating labeled ML features from the trained classifiers;
training a ML regression model with the extracted ML features and the labeled ML features;
receiving a new sales order; and
generating a prediction on a delivery date for the new sales order using the trained ML regression model.

2. The method of claim 1, wherein the prediction comprises a difference with respect to a previous estimated delivery date.

3. The method of claim 1, wherein the one or more classifiers comprise at least one of: a classifier to infer an importance of a customer; a classifier to infer a difficulty of a location for delivering on-time; a classifier to infer a complexity of manufacturing the item; or a classifier to infer an item shipping complexity.

4. The method of claim 3, wherein the labeled ML features are labeled as high, medium or low.

5. The method of claim 1, further comprising:
using the prediction and new sales order, when it has closed, to re-train the one or more classifiers and to re-train the ML regression model.

6. The method of claim 1, wherein the historical data is generated in part by tracking inventory items and transportation mechanisms using Internet of Things (IoT) based sensors.

7. The method of claim 1, wherein the training one or more classifiers comprising using semi-supervised clustering to label the portion of the plurality of ML features.

8. A computer readable medium having instructions stored thereon that, when executed by one or more processors, cause the processors to predict a sales order fulfillment of an item, the predicting comprising:
receiving historical data comprising past sales orders;
extracting a plurality of machine learning (ML) features from the historical data;
using a portion of the plurality of ML features to train one or more classifiers;
generating labeled ML features from the trained classifiers;
training a ML regression model with the extracted ML features and the labeled ML features;
receiving a new sales order; and
generating a prediction on a delivery date for the new sales order using the trained ML regression model.

9. The computer readable medium of claim 8, wherein the prediction comprises a difference with respect to a previous estimated delivery date.

10. The computer readable medium of claim 8, wherein the one or more classifiers comprise at least one of: a classifier to infer an importance of a customer; a classifier to infer a difficulty of a location for delivering on-time; a classifier to infer a complexity of manufacturing the item; or a classifier to infer an item shipping complexity.

11. The computer readable medium of claim 10, wherein the labeled ML features are labeled as high, medium or low.

12. The computer readable medium of claim 8, the predicting further comprising:
using the prediction and new sales order, when it has closed, to re-train the one or more classifiers and to re-train the ML regression model.

13. The computer readable medium of claim 8, wherein the historical data is generated in part by tracking inventory items and transportation mechanisms using Internet of Things (IoT) based sensors.

14. The computer readable medium of claim 8, wherein the training one or more classifiers comprising using semi-supervised clustering to label the portion of the plurality of ML features.

15. A cloud-based sales order predictor system for of an item, the system comprising:
a plurality of machine learning (ML) features extracted from historical data comprising past sales orders;
one or more classifiers that have been trained using a portion of the plurality of ML features, the trained classifiers adapted to generated labeled ML features; and
a trained ML regression model that has been trained with the extracted ML features and the labeled ML features, the trained ML regression model adapted to receive a new sales order and generate a prediction on a delivery date for the new sales order.

16. The cloud-based sales order predictor system of claim 15, wherein the prediction comprises a difference with respect to a previous estimated delivery date.

17. The cloud-based sales order predictor system of claim 15, wherein the one or more classifiers comprise at least one of: a classifier to infer an importance of a customer; a classifier to infer a difficulty of a location for delivering on-time; a classifier to infer a complexity of manufacturing the item; or a classifier to infer an item shipping complexity.

18. The cloud-based sales order predictor system of claim 17, wherein the labeled ML features are labeled as high, medium or low.

19. The cloud-based sales order predictor system of claim 15, further using the prediction and new sales order, when it has closed, to re-train the one or more classifiers and to re-train the ML regression model.

20. The cloud-based sales order predictor system of claim 15, wherein the historical data is generated in part by tracking inventory items and transportation mechanisms using Internet of Things (IoT) based sensors, further comprising:
an IoT gateway adapted to receiving IoT messages transmitted by the IoT based sensors.
